(19) United States
(12) Patent Application Publication
(10) Pub. No.: US 2017/0285435 A1
(43) Pub. Date: Oct. 5, 2017

(54) DISPLAY UNIT AND ELECTRONIC APPARATUS

(71) Applicant: Sony Corporation, Tokyo (JP)

(72) Inventor: Ryo Kasegawa, Kanagawa (JP)

(73) Assignee: Sony Corporation, Tokyo (JP)

(21) Appl. No.: 15/509,691

(22) PCT Filed: Sep. 3, 2015
(86) PCT No.: PCT/JP2015/075033

§ 371 Date: Mar. 8, 2017

(30) Foreign Application Priority Data
Sep. 16, 2014 (JP) 2014-187434

(51) Int. Cl. G02F 1/167; G02F 1/1335; G09G 3/20

(52) U.S. Cl. CPC G02F 1/167; G09G 3/2003; G02F 1/133514; G09G 3/344

(57) ABSTRACT

A display unit of the present disclosure includes a display layer and a color filter. The display layer has a plurality of pixels each including an electrophoretic element. The color filter is provided on a display side of the display layer on a portion of each of the pixels. The electrophoretic element in each of the pixels includes migrating particles, and one of the migrating particles and the color filter is a primary color, and the other is a color complementary to the primary color.

### TECHNICAL FIELD

The present disclosure relates to a display unit and an electronic apparatus that display an image by utilizing an electrophoretic phenomenon.

### BACKGROUND ART

In recent years, demand for low-power, high-image-quality display units has been growing, as various electronic apparatuses such as a mobile phone and a mobile information terminal (a personal digital assistant) have become widespread. In particular, recently, as electronic book delivery business has started, electronic book terminals for reading purpose have been receiving attention. The electronic book terminals are intended for reading character information for a long time. Display units having display quality suitable for this purpose are therefore expected.

Display units of types such as a cholesteric-liquid-crystal type, an electrophoretic type, an electric-redox type, and a twisting-ball type have been proposed as the display unit for reading purpose. In particular, a display unit classified into a reflection type may be preferable. This is because this type of display unit performs bright display by utilizing reflection (diffusion) of outside light as with paper, and thus may obtain display quality close to quality of paper. Another reason is that power consumption is suppressed since backlight is unnecessary.

A major candidate of the display unit of the reflection type is an electrophoretic-type display unit that effects light and shade (contrast) by utilizing an electrophoretic phenomenon. This is because this type of display unit consumes low power, and is superior in terms of fast response. On that account, various studies have been made for a display method of the electrophoretic-type display unit. Specifically, there is proposed a method in which two kinds of charged particles different in optical reflection property and polarity are dispersed in an insulating liquid, and the charged particles are each moved utilizing the difference in polarity. In this method, distribution of each of the two kinds of charged particles varies depending on an electric field, and therefore contrast occurs utilizing the difference in optical reflection property.

The electrophoretic-type display unit performs display by utilizing the contrast of reflected light as described above. Therefore, this display is basically monochromatic (monochrome). However, for example, it is also possible to perform color display by adding a color filter (e.g., refer to PTL 1). Improvements of display quality such as color gamut are desired for electronic paper displays that perform color display.

### CITATION LIST

### Patent Literature

PTL 1: Japanese Unexamined Patent Application Publication No. 2012-022296

However, there is such an issue that merely using the color filter decreases white reflectance, thus degrading display quality.

### SUMMARY OF THE INVENTION

Accordingly, it is desirable to provide a display unit and an electronic apparatus that allow for polychromatic display while improving display quality.

A display unit according to an embodiment of the present disclosure includes, a display layer and a color filter. The display layer has a plurality of pixels each including an electrophoretic element. The color filter is provided on a display side of the display layer on a portion of each of the pixels. The electrophoretic element in each of the pixels includes migrating particles, and one of the migrating particles and the color filter is a primary color, and the other is a color complementary to the primary color.

An electronic apparatus according to an embodiment of the present disclosure includes the display unit according to the embodiment of the present disclosure.

In the display unit and the electronic apparatus according to the respective embodiments of the present disclosure, the color filter is provided on the display side of the display layer including the electrophoretic element on the portion of each of the pixels. In addition, one of the color of the migrating particles included in the electrophoretic element and the color of the color filter is a primary color and the other is a color complementary to the primary color. Therefore, white reflectance improves, and it is possible to perform polychromatic display.

Specifically, for example, when one of the migrating particles and the color filter is colored in red, the other may be colored in cyan. When one of the migrating particles and the color filter is colored in green, the other may be colored in magenta. When one of the migrating particles and the color filter is colored in blue, the other may be colored in yellow. It is therefore possible to perform four color display of white display, black display, the color of the migrating particles, and the color of the color filter.

According to the display unit and the electronic apparatus of the respective embodiments of the present disclosure, the color filter is provided on the display side of the display layer including the electrophoretic element on the portion of each of the pixels. In addition, the color of the migrating particles included in the electrophoretic element and the color of the color filter form a complementary color relationship in which one of the colors is a primary color and the other is a color complementary to the primary color. Therefore, the white reflectance improves, and it is possible to perform the four color display of the white display, the black display, the color of the migrating particles, and the color of the color filter. Accordingly, it is possible to provide a display unit and an electronic apparatus that allow for polychromatic display, while improving display quality. It is to be noted that effects described here are non-limiting, and may be one or more of effects described in the present disclosure.

### BRIEF DESCRIPTION OF THE DRAWINGS

FIG. 1 is a cross-sectional diagram illustrating a configuration of a display unit according to an embodiment of the present disclosure.

Part (A) to Part (D) of FIG. 2 are schematic diagrams each illustrating an arrangement example of a color filter in a pixel.

FIG. 3 is a schematic diagram illustrating a configuration example of an electrophoretic element.

FIG. 4 is a cross-sectional schematic diagram for describing display operation of the display unit illustrated in FIG. 1.

Part (A) to Part (D) of FIG. 5 are plane schematic diagrams for description of the display operation of the display unit illustrated in FIG. 1.

FIG. 6 is a plan schematic diagram illustrating examples of a pixel of a display unit as a comparative example, where Part (A) illustrates a pixel having three colors and Part (B) illustrates a pixel having four colors.

FIG. 7A is a perspective view of an appearance of an electronic book using the display unit of the present disclosure.

FIG. 7B is a perspective view of another example of the electronic book illustrated in FIG. 7A.

FIG. 8 is a perspective view of an appearance of a personal computer using the display unit of the present disclosure.

### MODES FOR CARRYING OUT THE INVENTION

Some embodiments of the present disclosure will be described below in detail with reference to the drawings. It is to be noted that the description will be provided in the following order.
1. Embodiment (Display Unit)
   1-1. Configuration
   1-2. Manufacturing Method
   1-3. Workings and Effect
2. Application Examples (Electronic Apparatuses)

### 1. Embodiment

### 1-1. Configuration

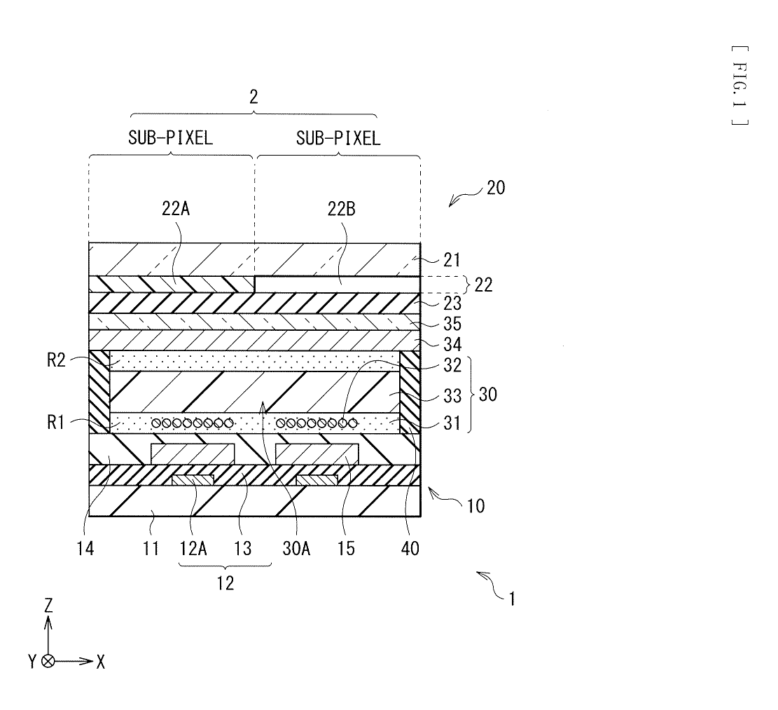

FIG. 1 illustrates a cross-sectional configuration of a display unit (a display unit 1) according to an embodiment of the present disclosure. The display unit 1 is applicable to various electronic apparatuses including a display unit that displays an image by effecting contrast utilizing an electrophoretic phenomenon. Examples of such a display unit may include an electronic paper display. The display unit 1 may include, for example, a drive substrate 10, a display substrate 20, and a display layer 30 interposed between the drive substrate 10 and the display substrate 20. The drive substrate 10 and the display substrate 20 may be disposed to face each other with a spacer 40 in between. The display layer 30 includes an electrophoretic element 30A. In the present embodiment, a plurality of pixels may be two-dimensionally arranged in a matrix. A filter layer 22 including a color filter 22A is formed in a portion of each of the pixels (pixels 2) of the display substrate 20. The electrophoretic element 30A may further include an insulating liquid 31, migrating particles 32, and a porous layer 33. The migrating particles 32 have a complementary color relationship with a color of the color filter 22A. The porous layer 33 may exhibit, for example, white. The migrating particles 32 and the porous layer 33 may be included in the insulating liquid 31. It is thereby possible to display a polychromatic image (here, four colors). It is to be noted that, in the present embodiment, the “pixel” may include a plurality of sub-pixels (e.g., two to four sub-pixels). Here, a case where four sub-pixels (sub-pixels 2n₁, 2n₂, 2n₃, and 2n₄) form one of the pixels (the pixels 2) will be described as an example (e.g., refer to Part (A) to Part (D) of FIG. 2). In addition, FIG. 1 schematically illustrates the configuration of the display unit 1, and an actual display unit may be different in size and shape from the display unit 1 illustrated in FIG. 1.

### (Drive Substrate 10)

The drive substrate 10 may include, for example, a thin-film transistor (TFT) layer 12, an adhesive layer 14, and a pixel electrode 15. The TFT layer 12, the adhesive layer 14, and the pixel electrode 15 may be stacked in this order on one surface of a support base 11. The TFT layer 12 may include a TFT 12A. For example, the TFT 12A and the pixel electrode 15 may be divided to form a matrix corresponding to a pixel arrangement to implement a drive circuit of an active matrix system.

The support base 11 may be formed of, for example, one kind or two or more kinds of materials such as an inorganic material, a metallic material, and a plastic material. Examples of the inorganic material may include silicon (Si), silicon oxide (SiOₓ), silicon nitride (SiNₓ), and aluminum oxide (AlOₓ). Examples of the silicon oxide may include glass and spin-on-glass (SOG). Examples of the metallic material may include aluminum (Al), nickel (Ni), and stainless steel. Examples of the plastic material may include polycarbonate (PC), polyethylene terephthalate (PET), polyethylene naphthalate (PEN), polyethyl ether ketone (PEEK), cycloolefin polymer (COP), polyimide (PI), and polyether sulfone (PES).

The support base 11 may have optical transparency, or may have non-optical transparency. In addition, the support base 11 may be a rigid substrate such as a wafer, or may be a thin-layer glass or a film having flexibility. However, a material having flexibility may be desirable because this material makes it possible to realize a flexible (foldable) electronic paper display.

The TFT 12A may be a switching element for pixel selection. The TFT 12A may be, for example, an inorganic TFT using, as a channel layer (an active layer), an inorganic semiconductor layer such as amorphous silicon, poly-silicon, and oxide. Alternatively, the TFT 12A may be an organic TFT using, as a channel layer, an organic semiconductor layer such as pentacene. In the TFT layer 12, the TFT 12A may be covered with, for example, a protective layer 13. In addition, a planarization insulating film (not illustrated) made of, for example, an insulating material such as polyimide may be provided on the protective layer 13.

The adhesive layer 14 may be formed when the display layer 30 is formed on the TFT layer 12. The adhesive layer 14 may be made of, for example, an acrylic-based resin, a urethane-based resin, or rubber. The adhesive layer 14 may have a thickness of, for example, 1 μm to 100 μm both inclusive. It is to be noted that, for example, an additive such as an anionic additive, a cationic additive, or a lithium salt-based additive may be added to the adhesive layer 14 to provide conductivity.

The pixel electrode 15 may be formed independently for each of the sub-pixels 2n₁, 2n₂, 2n₃, and 2n₄. The pixel electrode 15 may include, for example, one kind or two or more kinds of conductive materials such as gold (Au), silver (Ag), and copper (Cu). The pixel electrode 15 is electrically coupled to the TFT 12A. It is to be noted that the number of the TFTs 12A disposed for the one pixel electrode 15 is any number, and may be two or more, without being limited to one.

### (Display Substrate 20)

The display substrate 20 may include, for example, the filter layer 22, a bonding layer 23, a transparent substrate 35, and a counter electrode 34 stacked in this order on one-surface side (on a side where the display layer 30 is provided) of a transparent substrate 21.

The transparent substrate 21 may be made of a material similar to the material of the support base 11 except for having optical transparency. It is necessary for the transparent substrate 21 to have optical transparency, since an image is displayed on a top-surface side of the display substrate 20. The transparent substrate 21 may have a thickness of, for example, 1 μm to 250 μm both inclusive.

In the filter layer 22, the color filter 22A having a predetermined color may be disposed to face each of the pixels 2, on a portion (one region) of the pixel 2. Here, the one region is a sub-pixel unit. Specifically, assume that the one pixel includes the four sub-pixels. In this case, the color filter 22A is disposed at one sub-pixel (e.g., the sub-pixel 2n₁) to three sub-pixels (e.g., the sub-pixels 2n₂, 2n₃, and 2n₄) of the four sub-pixels, as illustrated in Part (A) to Part (D) of FIG. 2. It is to be noted that the cross-sectional diagram of the display unit 1 illustrated in FIG. 1 represents a cross section taken along a broken line I-I in Part (A) of FIG. 2. When the filter layer 22 is disposed at two of the four sub-pixels, a checkered pattern (e.g., the sub-pixels 2n₁ and 2n₄) may be formed as illustrated in Part (B) of FIG. 2, or a linear pattern (e.g., the sub-pixels 2n₁ and 2n₂) may be formed as illustrated in Part (C) of FIG. 2. A position where the color filter 22A is disposed in each of the pixels 2 may be any position. The color filter 22A may be disposed at a same position or different positions in the respective pixels 2.

The color of the color filter 22A is not limited in particular, but may preferably have a complementary color relationship with the migrating particles 32 to be described later. It may be preferable to use, for example, any of red (R), green (G), and blue (B), or any of cyan (C), magenta (M), and yellow (Y). In particular, using any of cyan, magenta, and yellow improves reflectance in white display.

It is to be noted that the filter layer 22 may be directly drawn on one surface of the transparent substrate 21, or may be fixed onto the transparent substrate 21 with, for example, as an adhesive. In addition, an opening 22B where the color filter 22A is not provided may be a hollow, or may be filled with a transparent resin material having optical transparency.

The bonding layer 23 may be a layer formed for adhesion between the filter layer 22 and the transparent substrate 35. The bonding layer 23 may be made of a material such as ultraviolet curable resin having optical transparency. Examples of such a resin material may include an acrylic-based resin, an epoxy-based resin, and a polyester-based resin. The bonding layer 23 may have a thickness of, for example, 0.1 μm to 50 μm both inclusive.

The transparent substrate 35 may be made of a material similar to the material of the support base 11 except for having optical transparency. The transparent substrate 35 may have flexibility, or may have rigidity. It is necessary for the transparent substrate 35 to have the optical transparency, since an image is displayed on a side where the display substrate 20 is provided. The transparent substrate 35 may have a thickness of, for example, 0.1 μm to 125 μm both inclusive.

The counter electrode 34 may include, for example, one kind or two or more kinds of conductive materials (transparent conductive materials) having translucency. Examples of such conductive materials may include indium oxide-tin oxide (ITO), antimony oxide-tin oxide (ATO), fluorine-doped tin oxide (FTO), and aluminum-doped zinc oxide (AZO). The counter electrode 34 may have a thickness of, for example, 0.001 μm to 1 μm both inclusive. It is to be noted that the counter electrode 34 may be formed, for example, on an entire surface of the transparent substrate 35. However, the counter electrode 34 may be formed, for example, in such a manner that the counter electrode 34 is divided for each of the sub-pixels 2n₁, 2n₂, 2n₃, and 2n₄, as with the pixel electrode 15.

When an image is displayed on the display substrate 20 side, the electrophoretic element 30A is viewed through the counter electrode 34. Therefore, the counter electrode 34 may preferably have highest possible optical transmittance. The optical transmittance of the counter electrode 34 may be, for example, 80% or more. In addition, the counter electrode 34 may preferably have lowest possible electric resistance. The electric resistance of the counter electrode 34 may be, for example, 100Ω/square or less.

### (Display Layer 30)

The display layer 30 includes the electrophoretic element 30A that may be, for example, voltage-controlled for each of the sub-pixels 2n₁, 2n₂, 2n₃, and 2n₄. The electrophoretic element 30A effects contrast by utilizing an electrophoretic phenomenon. The electrophoretic element 30A includes the migrating particles 32 movable between the pixel electrode 15 and the counter electrode 34 in response to an electric field. Specifically, the electrophoretic element 30A may include, for example, the porous layer 33, in addition to the migrating particles 32, in the insulating liquid 31. It is to be noted that, here, the insulating liquid 31 and the porous layer 33 of the electrophoretic element 30A are common to each of the pixels.

The insulating liquid 31 may include, for example, one kind or two or more kinds of nonaqueous solvent such as an organic solvent. Specifically, the insulating liquid 31 may include a solvent such as paraffin and isoparaffin. The insulating liquid 31 may have, preferably, lowest possible viscosity and a lowest possible refractive index. This is because mobility (a response speed) of the migrating particles 32 improves, and energy (power consumption) necessary for movement of the migrating particles 32 decreases accordingly. Another reason is that a difference between the refractive index of the insulating liquid 31 and a refractive index of the porous layer 33 widens, thereby increasing an optical reflectance of the porous layer 33. It is to be noted that a week conductive liquid may be used in place of the insulating liquid 31.

It is to be noted that the insulating liquid 31 may include various materials as necessary. Examples of these materials may include a coloring agent, a charge control agent, a dispersion stabilizer, a viscosity modifier, a surfactant, and a resin.

The migrating particles 32 may be one or more particles electrically movable. The migrating particles 32 may be dispersed in the insulating liquid 31. The migrating particles 32 may be movable between the pixel electrode 15 and the counter electrode 34, in the insulating liquid 31. For example, the migrating particles 32 may be particles (powder) made of one kind or two or more kinds of materials such as an organic pigment, an inorganic pigment, a dye, a carbon material, a metallic material, a metal oxide, glass, and a polymer material (resin). It is to be noted that the migrating particles 32 may be particles such as crushed particles or capsule particles of a resin solid including the above-described particles. However, materials corresponding to the carbon material, the metallic material, the metal oxide, the glass, and the polymer material are excluded from materials corresponding to the organic pigment, the inorganic pigment, and the dye.

Examples of the organic pigment may include an azo-based pigment, a metal-complex-azo-based pigment, a polycondensed azo-based pigment, a flavanthrone-based pigment, a benzimidazolone-based pigment, a phthalocyanine-based pigment, a quinacridone-based pigment, an anthraquinone-based pigment, a perylene-based pigment, a perinone-based pigment, an anthrapyridine-based pigment, a pyranthrone-based pigment, a dioxazine-based pigment, a thioindigo-based pigment, an isoindolinone-based pigment, a quinophthalone-based pigment, and an indanthrene-based pigment. Examples of the inorganic pigment may include zinc flower, antimony white, carbon black, black iron oxide, titanium boride, red iron oxide, mapico yellow, minium, cadmium yellow, zinc sulphide, lithopone, barium sulfide, cadmium selenide, calcium carbonate, barium sulfate, lead chromate, lead sulfate, barium carbonate, white lead, and alumina white. Examples of the dye may include a nigrosine-based dye, an azo-based dye, a phthalocyanine-based dye, a quinophthalone-based dye, an anthraquinone-based dye, and a methine-based dye. Examples of the carbon material may include carbon black. Examples of the metallic material may include gold, silver, and copper. Examples of the metal oxide may include titanium oxide, zinc oxide, zirconium oxide, barium titanate, potassium titanate, copper-chromium oxide, copper-manganese oxide, copper-iron-manganese oxide, copper-chromium-manganese oxide, and copper-iron-chromium oxide. Examples of the polymer material may include a polymer compound into which a functional group having an optical absorption region in a visible light region is introduced. As long as the polymer compound having the optical absorption region in the visible light region is used, the type thereof is not limited in particular.

A content (concentration) of the migrating particles 32 in the insulating liquid 31 is not limited in particular, and may be, for example, 0.1 wt % to 10 wt % both inclusive. This is because covering (opacifying) properties and mobility of the migrating particles 32 are ensured. In this case, it may be difficult for the migrating particles 32 to cover the porous layer 33, if the content is less than 0.1 wt %. On the other hand, if the content is more than 10 wt %, dispersibility of the migrating particles 32 may decrease, making migration of the migrating particles 32 difficult, or the migrating particles 32 may be agglomerated in some cases.

In addition, the migrating particles 32 have any given optical reflection property (optical reflectance). The optical reflectance of the migrating particles 32 is not limited in particular, but may preferably be set at least to allow the migrating particles 32 to cover the porous layer 33. This is because the contrast is effected by utilizing a difference between the optical reflectance of the migrating particles 32 and the optical reflectance of the porous layer 33.

A specific material of the migrating particles 32 may be selected by, for example, a role taken by the migrating particles 32 to effect the contrast. Examples of a material when the migrating particles 32 perform bright display may include metal oxide such as titanium oxide, zinc oxide, zirconium oxide, barium titanate, and potassium titanate. Above all, the titanium oxide may be preferable. This is because the titanium oxide is superior in terms of, for example, electrochemical stability and dispersibility, and high reflectance is obtained. Examples of a material when the migrating particles 32 perform dark display (black display) may include a carbon material and metal oxide. Examples of the carbon material may include carbon black. Examples of the metal oxide may include copper-chromium oxide, copper-manganese oxide, copper-iron-manganese oxide, copper-chromium-manganese oxide, and copper-iron-chromium oxide. Above all, the carbon material may be preferable. This is because superior chemical stability, mobility, and light absorption property are obtained.

In the present embodiment, the migrating particles 32 may exhibit a color complementary to the color of the color filter 22A, as described above. Specifically, the migrating particles 32 may exhibit, preferably, red (R), green (G), and blue (B) when the color filter 22A is cyan (C), magenta (M), and yellow (Y), respectively. This makes it possible to perform four-color display of the white display, the black display, the color (e.g., red display) of the migrating particles 32, and the color (e.g., cyan display) of the color filter 22A, as will be described later in detail. It is possible to form the migrating particles 32 by using, for example, a pigment exhibiting each of the colors. Examples of a specific material may include polycyclic pigments such as quinacridone, perylene, perinone, isoindolinone, dioxazine, isoindoline, anthraquinone, quinophthalone, and diketo-pyrrolo-pyrrole, phthalocyanine pigments, azo pigments such as azo yellow lake, azo lake red, pyrazolone, disazo, monoazo, condensed azo, naphthol, and benzimidazolone, and inorganic pigments such as cadmium yellow, strontium chromate, viridian, oxide chromium, cobalt blue, and ultramarine blue.

It is to be noted that, preferably, the migrating particles 32 may be easily dispersed and charged with electricity in the insulating liquid 31 for a long time, and may also be resistant to adherence to the porous layer 33. To this end, a dispersant (or an electric charge modifier) may be used to disperse the migrating particles 32 by electrostatic repulsion, or the migrating particles 32 may be subjected to a surface treatment. Alternatively, both the dispersant and the surface treatment may be used together.

Examples of the dispersant may include the Solsperse series available from the Lubrizol Corporation, the BYK series and the Anti-Terra series available from BYK-Chemie GmbH, and the Span series available from the ICI Americas, Inc.

Examples of the surface treatment may include a rosin treatment, a surfactant treatment, a pigment derivative treatment, a coupling agent treatment, a graft polymerization treatment, and a microencapsulation treatment. In particular, the graft polymerization treatment, the microencapsulation treatment, and a combination thereof may be preferable, which makes it possible to obtain, for example, long-term dispersion stability.

Examples of a material for the surface treatment may include a material (an adsorptive material) having a functional group and a polymeric functional group that are adsorbable on surfaces of the migrating particles 32. A type of the adsorbable functional group is determined by the material of the migrating particles 32. Examples may include an aniline derivative such as 4-vinyl aniline for the carbon material such as carbon black, and an organosilane derivative such as methacrylate 3-(trimethoxysilyl) propyl for the metal oxide. Examples of the polymeric functional group may include a vinyl group, an acrylic group, and a methacryl group.

In addition, examples of the material for the surface treatment may include a material (a graft material) allowed to be grafted onto the surfaces of the migrating particles 32 into which the polymeric functional group is introduced. The graft material may preferably include a polymeric functional group and a functional group for dispersion. The functional group for dispersion is dispersible in the insulating liquid 31, and allowed to maintain dispersibility by steric hindrance. A type of the polymeric functional group is similar to the type used in the description of the adsorptive material. Examples of the functional group for dispersion may include a branched-alkyl group when the insulating liquid 31 is paraffin. For example, a polymerization initiator such as azobisisobutyronitrile (AIBN) may be used to effect polymerization and grafting of the graft material.

For reference, details of the way of dispersing the migrating particles 32 in the insulating liquid 31 as described above are discussed in books such as “Dispersion technology of ultrafine particles and evaluation thereof: surface treatment and fine grinding, and dispersion stability in air/liquid/polymer (Science & Technology Co., Ltd.)”.

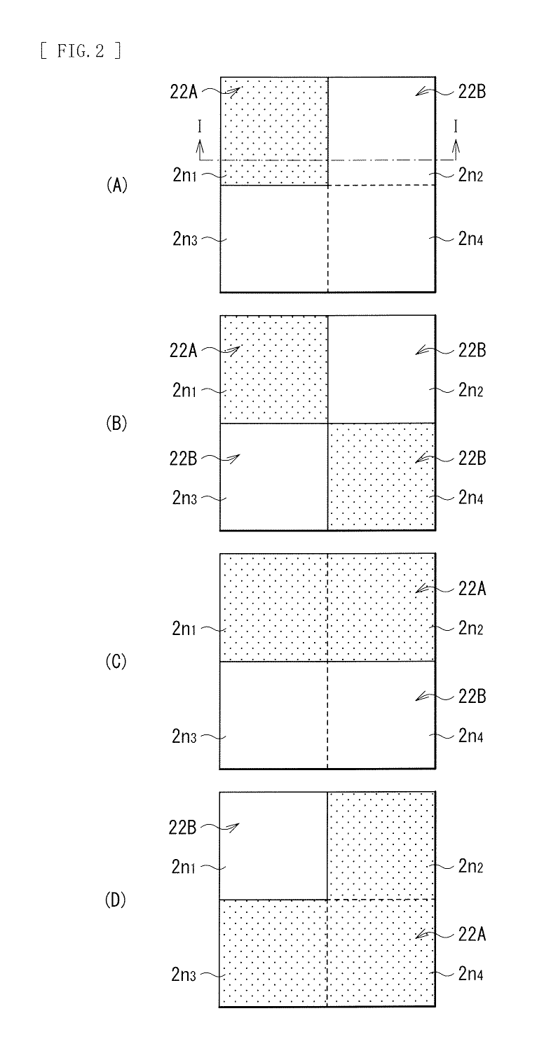

The porous layer 33 may be, for example, a three-dimensional structure (an irregular network structure such as a nonwoven fabric) formed using a fibrous structure 331 as illustrated in FIG. 3. The porous layer 33 may have a plurality of clearances (pores H) formed to allow the migrating particles 32 to pass therethrough. The clearances may be provided in a region where the fibrous structure 331 is not present. It is to be noted that illustration of the porous layer 33 is simplified in FIG. 1.

The fibrous structure 331 may include one or more non-migrating particles 332. The non-migrating particles 332 may be held by the fibrous structure 331. In the porous layer 33 with the three-dimensional structure, the single fibrous structure 331 may be twisted at random. Alternatively, a plurality of fibrous structures 331 may be collected and stacked at random. Still alternatively, both the single fibrous structure 331 and the plurality of fibrous structures 331 may be present in a mixed manner. When the plurality of fibrous structures 331 are present, each of the fibrous structures 331 may preferably hold one or more non-migrating particles 332. It is to be noted that FIG. 3 illustrates a case where that the porous layer 33 is formed of the plurality of fibrous structures 331.

The porous layer 33 may have the three-dimensional structure for the following reason. This irregular three-dimensional structure easily causes diffused reflection (multiple scattering) of outside light, which increases the optical reflectance of the porous layer 33. In addition, the porous layer 33 may be thin to obtain such a high optical reflectance. This increases the contrast, and reduces energy necessary for movement of the migrating particles 32. Another reason is that the migrating particles 32 are made to pass through the pore H easily, because an average pore size of the pore H increases, and the number of the migrating particles 32 grows. This reduces time necessary for movement of the migrating particles 32, and lowers the energy necessary for the movement of the migrating particles 32 as well.

The non-migrating particles 332 may be included in the fibrous structure 331, because the diffused reflection of the outside light occurs more easily, and the optical reflectance of the porous layer 33 further increases. This further increases the contrast.

The fibrous structure 331 may be a fibrous substance having a sufficient length with respect to a fiber diameter (a diameter). The fibrous structure 331 may include, for example, one kind or two or more kinds of polymer materials and inorganic materials, and may include other material. Examples of the polymer materials may include nylon, polylactic acid, polyamide, polyimide, polyethylene terephthalate, polyacrylonitrile, polyethyleneoxide, polyvinylcarbazole, polyvinyl chloride, polyurethane, polystyrene, polyvinyl alcohol, polysulfone, polyvinylpyrrolidone, polyvinylidene fluoride, polyhexafluoropropylene, cellulose acetate, collagen, gelatin, chitosan, and copolymers of these materials. Examples of the inorganic materials may include titanium oxide. Above all, the polymer material may be preferable for the material of the fibrous structure 331. This is because the polymer material has low reactivity (photoreactivity) (chemical stability) and therefore an unintended decomposition reaction of the fibrous structure 331 is suppressed. It is to be noted that when the fibrous structure 331 is formed of a material with high reactivity, the fibrous structure 331 may preferably have a surface covered with any given protective layer.

The fibrous structure 331 is not limited in particular in terms of shape (appearance), as long as the length is sufficiently long with respect to the fiber diameter as described above. Specifically, the fibrous structure 331 may be linear, curled, or bent at some point. Alternatively, the fibrous structure 331 may be branched at some point to one or two directions, without being limited to extending in one direction. A method of forming the fibrous structure 331 is not limited in particular. However, the method may preferably be, for example, a phase separation method, a phase inversion method, an electrostatic (electric field) spinning method, a melt spinning method, a wet spinning method, a dry spinning method, a gel spinning method, a sol-gel method, or a spray coating method. This is because a fibrous substance having a length sufficiently long with respect to a fiber diameter is formed easily and stably.

The fibrous structure 331 has an average fiber diameter not limited in particular, but may preferably have a smallest possible average fiber diameter. This is because diffused reflection of light easy occurs, and an average pore size of the pore H increases. However, it is necessary to determine the average fiber diameter to allow the fibrous structure 331 to hold the non-migrating particles 332. For this reason, the average fiber diameter of the fibrous structure 331 may preferably be 10 μm or less. It is to be noted that a lower limit of the average fiber diameter is not limited in particular, and may be, for example, 0.1 μm or less. The average fiber diameter may be measured by, for example, microscopic observation using a scanning electron microscope (SEM). It is to be noted that the fibrous structure 331 may have any given average length.

The average pore size of the pore H is not limited in particular, but may preferably be as large as possible. This is because the migrating particles 32 are allowed to pass through the pore H easily. For this reason, the average pore size of the pore H may preferably be 0.1 μm to 10 μm both inclusive.

The porous layer 33 has a thickness not limited in particular, but this thickness may be, for example, 5 μm to 100 μm both inclusive. This is because covering properties of the porous layer 33 increase, and the migrating particles 32 are allowed to pass through the pore H easily.

In particular, the fibrous structure 331 may preferably be a nanofiber. This is because a complicated three-dimensional structure is provided to effect the diffused reflection of the outside light easily. This further increases the optical reflectance of the porous layer 33, and raises a ratio of volume of the pore H in a unit volume of the porous layer 33. The migrating particles 32 are thereby allowed to pass through the pore H easily. As a result, the contrast further increases, and the energy necessary for the movement of the migrating particles 32 further decreases. The nanofiber may be a fibrous substance having a fiber diameter of 0.001 μm to 0.1 μm both inclusive, and a length 100 times longer than the fiber diameter. The fibrous structure 331, which is the nanofiber, may preferably be formed by an electrostatic spinning method using a polymer material. This is because the fibrous structure 331 having a small fiber diameter is formed easily and stably.

The fibrous structure 331 may preferably have an optical reflection property different from that of the migrating particles 32. Specifically, the optical reflectance of the fibrous structure 331 is not limited in particular, but may preferably be set to allow at least the porous layer 33 as a whole to cover the migrating particles 32. This is to effect the contrast by utilizing the difference between the optical reflectance of the migrating particles 32 and the optical reflectance of the porous layer 33 as described above. Accordingly, the fibrous structure 331 having optical transparency (colorlessness and transparency) in the insulating liquid 31 may not be preferable. However, in a case where the optical reflectance of the fibrous structure 331 hardly affects the optical reflectance of the entire porous layer 33, and the optical reflectance of the entire porous layer 33 is determined substantially by an optical reflectance of the non-migrating particles 332, the fibrous structure 331 may have any given optical reflectance.

The non-migrating particles 332 may be particles fixed to the fibrous structure 331, and not migrating electrically. A material of the non-migrating particles 332 may be, for example, similar to the material of the migrating particles 32. The material of the non-migrating particles 332 may be selected by a role of the non-migrating particles 332, as will be described later.

It is to be noted that the non-migrating particles 332 may be partially exposed from the fibrous structure 331 or may be buried in the fibrous structure 331, as long as the non-migrating particles 332 are held by the fibrous structure 331.

The non-migrating particles 332 may have an optical reflection property different from that of the migrating particles 32. The optical reflectance of the non-migrating particles 332 is not limited in particular, but may preferably be set to allow at least the porous layer 33 as a whole to cover the migrating particles 32. This is to display the contrast by utilizing the difference between the optical reflectance of the migrating particles 32 and the optical reflectance of the porous layer 33 as described above.

Here, a specific material of the non-migrating particles 332 may be selected, for example, by a role taken by the non-migrating particles 332 to effect the contrast. Specifically, a material when the non-migrating particles 332 perform bright display may be similar to the above-described material of the migrating particles 32 selected when the bright display is performed. A material when the non-migrating particles 332 perform dark display may be similar to the above-described material of the migrating particles 32 selected when the dark display is performed. The material to be selected when the non-migrating particles 332 perform the bright display as in the present embodiment may preferably be metal oxide, and may be more preferably titanium oxide. This is because properties such as electrochemical stability and fixity are superior, and high reflectance is obtainable. The material of the non-migrating particles 332 may be the same as or different from the material of the migrating particles 32, as long as it is possible to effect the contrast.

An example of a procedure of forming the porous layer 33 is as follows. First, a spinning solution is prepared by dispersing or dissolving the material (e.g., the material such as the polymer material) of the fibrous structure 331, in a solvent such as an organic solvent. Next, the non-migrating particles 332 are added to the spinning solution. The spinning solution is stirred sufficiently, which scatters the non-migrating particles 332 in the spinning solution. Finally, spinning is performed by an electrostatic spinning method using the spinning solution. As a result, the non-migrating particles 332 are held by the fibrous structure 331, and the porous layer 33 is thus formed.

The spacer 40 may include, for example, an insulating material such as a polymer material. However, the spacer 40 is not limited in particular in term of configuration, and may be a seal material mixed with fine particles.

The spacer 40 is not limited in particular in terms of shape. However, the spacer 40 may preferably have a shape that does not disturb the movement of the migrating particles 32 between the pixel electrode 15 and the counter electrode 34 and is allowed to uniformly distribute the migrating particles 32. The spacer 40 may preferably have a grid shape. In addition, the spacer 40 is not limited in particular in terms of thickness. However, this thickness may preferably be as thin as possible to reduce the power consumption, and may be, for example, 10 μm to 100 μm both inclusive. It is to be noted that, in FIG. 1, the configuration of the spacer 40 is simplified.

(Preferable Display Method for Electrophoretic element)

In the electrophoretic element 30A, the contrast may be effected by utilizing the difference between the optical reflectance of the migrating particles 32 and the optical reflectance of the porous layer 33 as described above. In the present embodiment, the migrating particles 32 may perform the dark display, and the porous layer 33 may perform the bright display. Such a difference in role may be determined by a relationship between the optical reflectance of the migrating particles 32 and the optical reflectance of the porous layer 33. In other words, the optical reflectance of a part performing the bright display may be set to be higher than the optical reflectance of a part performing the dark display.

In particular, preferably, the migrating particles 32 may perform the dark display, and the porous layer 33 may perform the bright display. This is because the optical reflectance of the porous layer 33 is higher than the optical reflectance of the migrating particles 32. Accordingly, when the optical reflectance of the porous layer 33 is determined by the optical reflectance of the non-migrating particles 332, the optical reflectance of the non-migrating particles 332 may preferably be higher than the optical reflectance of the migrating particles 32. This is because the optical reflectance of the bright display greatly increases by utilizing the diffused reflection of the outside light by the porous layer 33, and accordingly the contrast greatly increases as well.

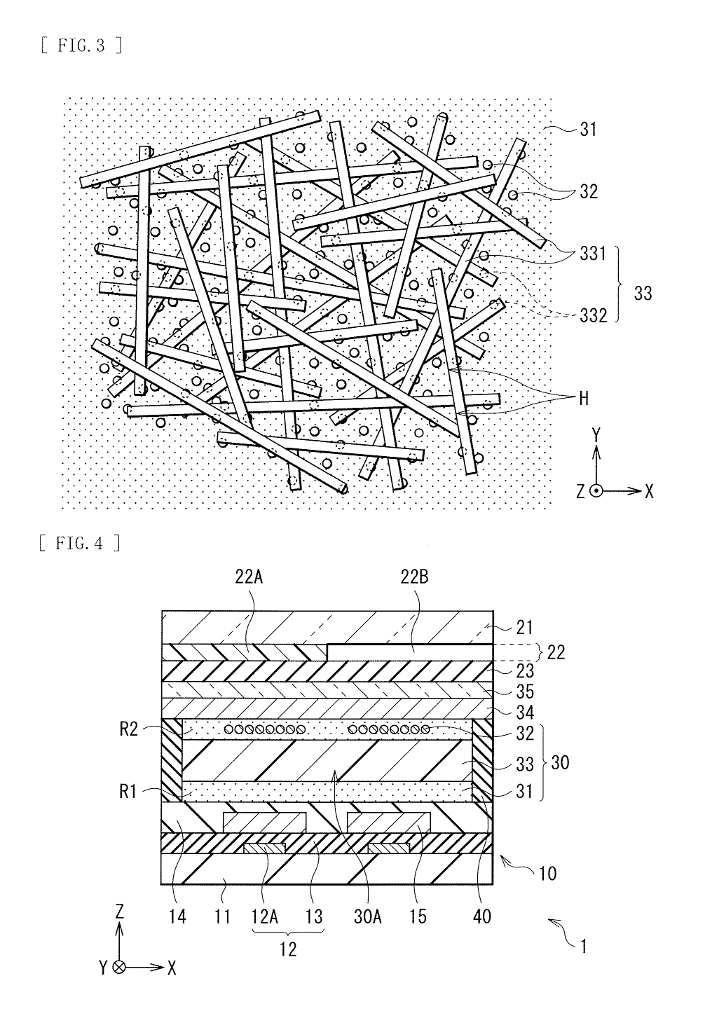

FIG. 4 is a schematic diagram for description of display operation of the electrophoretic element 30A. For example, the migrating particles 32 may be located in a standby region R1 (FIG. 1), in the electrophoretic element 30A in an initial state. In this case, the migrating particles 32 may be covered with the porous layer 33 in all pixels. This is in a state where no contrast is effected (no image is displayed) when the electrophoretic element 30A is viewed from the transparent substrate 21 side.

When any of the sub-pixels 2n₁, 2n₂, 2n₃, and 2n₄ in the pixel 2 is selected by the TFT 12A, and an electric field is applied between the pixel electrode 15 and the counter electrode 34, the migrating particles 32 may move from the standby region R1 to a display region R2 for each pixel, via the porous layer 33 (the pore H) as illustrated in FIG. 4. In this case, the sub-pixel where the migrating particles 32 are covered with the porous layer 33 and the sub-pixel where the migrating particles 32 are not covered with the porous layer 33 are both present. This is a state where contrast is effected when the electrophoretic element 30A is viewed from the transparent substrate 21 side. An image is thus displayed.

It is to be noted that the drive substrate 10 may include a peripheral circuit (not illustrated) provided to drive the above-described electrophoretic element 30A for each of the sub-pixels (to apply a drive voltage between the pixel electrode 15 and the counter electrode 34). The peripheral circuit may include, for example, components such as a driver for voltage control to form a drive circuit of an active matrix system, a power supply, and a memory. The peripheral circuit is allowed to apply a drive voltage corresponding to an image signal to one or more selective sub-pixels.

### 1-2. Manufacturing Method (Color Filter Implementing Method)

In the display unit 1 described above, the filter layer 22 (the color filter 22A) may be directly drawn on a display body in a manufacturing process. Alternatively, the filter layer 22 may be fabricated as a module different from a display body, and then the module and the display body may be bonded with the bonding layer 23. Here, a case where the filter layer 22 is fabricated as a module different from a display body will be described as an example. It is to be noted that the display body here corresponds to a stacked body of a stacked structure of the display unit 1 described above. The stacked body includes the drive substrate 10 (a supporting substrate 11, the TFT layer 12 (the TFT 12A and the protective layer 13), and the pixel electrode 15), the adhesive layer 14, the display unit 30, the counter substrate 34, and the transparent substrate 35.

First, a glass plate having a plane area larger than the display layer 30 (a pixel region) may be prepared. An alignment mark may be then formed at a predetermined position of this glass plate. It may be possible to form the alignment mark by using, for example, a photoresist (a so-called black resist) containing a black pigment or dye. It is to be noted that, as will be described later in detail, the glass plate maybe a supporting member for bonding of the filter layer 22 and the display body, and then peeled off after the bonding.

Next, the transparent substrate 21 may be temporarily fixed to the glass plate by adhesion of the transparent substrate 21 to one surface (a surface where the alignment mark is formed) of the glass plate. In this process, specifically, the transparent substrate 21 in a film shape may be bonded onto the glass plate by a roller, after applying an adhesive material onto the glass plate by, for example, a spin coater, a bar coater, a gravure press, or a slit coater. Examples of the adhesive material may include an adhesive material of an ultraviolet foaming type and an adhesive material of a heat foaming type. Alternatively, the transparent substrate 21 may be bonded onto the glass plate by a roller, after a film-shaped adhesive sheet of an ultraviolet foaming type is bonded onto the glass plate by a roller.

Next, the filter layer 22 may be formed on the transparent substrate 21. Specifically, for example, the color filter 22A of cyan may be patterned in a selective region (a region facing the display layer 30) on the transparent substrate 21. Subsequently a portion (a circumferential portion), in which the filter layer 22 is not formed, of the transparent substrate 21 may be removed by cutting. This is to avoid protrusion of the transparent substrate 21 from an electrode region of the thin-film transistor, after the filter layer 22 and the display body are bonded together, in a process to be described later.

Next, for example, an ultraviolet curable adhesive may be applied onto the filter layer 22, and then the filter layer 22 is bonded to the display body. Specifically, first, the filter layer 22 supported by the glass plate may be placed to face a top surface (the transparent substrate 35) of the display body with the adhesive provided therebetween. It is to be noted that an alignment mark to engage with the above-described alignment mark may be formed beforehand on the drive substrate 10 (specifically, the support base 11) of the display body. Afterward, alignment may be performed while monitoring each of the alignment marks with, for example, a camera. The filter layer 22 and the display body may be then joined to each other and subsequently pressed.

The filter layer 22 may be then temporarily fixed onto the display body. Specifically, the filter layer 22 and the display body joined to each other with the adhesive in between may be irradiated with an ultraviolet ray (UV). To be more specific, only a selective region (here, four corners of the filter layer 22) may be irradiated with the UV to cure the adhesive in the region. Next, the entirety of the display body and the filter layer 22 temporarily fixed to each other may be irradiated with UV to cure the entirety of the adhesive. The filter layer 22 may be thereby bonded to the display body with the bonding layer 23 in between.

Finally, the glass plate maybe peeled off, which completes the display unit 1 illustrated in FIG. 1.

### 1-3. Workings and Effect

### (Color Display Operation)

Next, operation of the display unit 1 of the present embodiment will be described. Part (A) to Part (D) of FIG. 5 are provided for description of the display operation of the display unit 1. The display unit 1 of the present embodiment includes the electrophoretic element 30A as the display body, as described above. Here, for example, the color filter 22A of cyan may be disposed in a portion (one or more of the sub-pixel 2n₁, 2n₂, 2n₃, and 2n₄) of the pixel 2. In the electrophoretic element 30A, the migrating particles 32 are colored in a color (a primary color, here, red) complementary to the color of the color filter 22A, and red display is performed. In the present embodiment, the dark display corresponds to the color (the red display) of the migrating particles 32, and the bright display corresponds to the white display by the porous layer 33, in the above description of the display method of the electrophoretic element 30A.

In the display unit 1 of the present embodiment, the outside light (white light) reflected by the porous layer 30 is outputted from the display layer 30. The outside light (white light) then passes through the color filter 22A, in a region (here, the sub-pixel 2n₁) where the color filter 22A is provided. In the sub-pixel 2n₁, light of a specific wavelength corresponding to the color filter 22A is therefore outputted to outside via the display substrate 20. In addition, in a region of the opening 22B where the color filter 22A is not provided, the light (the light reflected in the porous layer 33) outputted from the display layer 30 is outputted to the outside as white light.

First, for example, a case (the state in FIG. 1) where the migrating particles 32 are localized on the pixel electrode 15 side within the pixel 2 will be described as the above-described initial state (a state where no voltage is applied to the entire region of the display layer 30). Here, the migrating particles 32 are localized on the pixel electrode 15 side (the standby region R1; the region between the porous film 33 and the pixel electrode 15). In the display layer 30, the migrating particles 32 are covered with the porous layer 33, and a state illustrated in Part (D) of FIG. 5 is established when the pixel 2 is viewed from the display substrate 20 side. In this state, no image is displayed because no contrast of light and shade is effected among the sub-pixels 2n₁, 2n₂, 2n₃, and 2n₄. The display color in the pixel 2 is the color (cyan) of the color filter 22A.

When a predetermined drive voltage is subsequently applied to any of the sub-pixels 2n₁, 2n₂, 2n₃, and 2n₄ selected on the basis of an image signal, in the selected sub-pixel, an electric field is generated in the display layer 30, and the migrating particles 32 move from the pixel electrode 15 side toward the counter electrode 34. For each pixel, a layer state between the migrating particles 32 and the porous layer 33 in the insulating liquid therefore changes, and the optical reflectance changes. In other words, the contrast is effected by a reflection light quantity (an output light quantity) difference between the pixels, and an image is thus formed.

Assume that, at this moment, the selected sub-pixel is one sub-pixel (e.g., the sub-pixel 2n₄) where the color filter 22A is not provided among the four sub-pixels, as illustrated in Part (A) of FIG. 5. In this case, the display color in the pixel 2 is white (the white display) by additive color mixture. It is to be noted that, in the white display, an area occupied by the migrating particles 32 on the display substrate 20 side (the display region R2 side) may be about the same as a placement area of the color filter 22A (about 1:1). For this reason, in Part (A) of FIG. 5, the migrating particles 32 are present in the sub-pixel n4 diagonally opposite to the color filter 22A. However, without being limited to this sub-pixel, the migrating particles 32 may be present in the sub-pixel 2n₂ or the sub-pixel 2n₃.

In addition, in the white display by the additive color mixture, balance in which reflected light intensity in the pixel 2 is white is provided. For this reason, it is possible to perform the white display by not only adjusting the area ratio as described above, but also adjusting the light reflection quantity of each of the sub-pixels 2n₁, 2n₂, 2n₃, and 2n₄. It is possible to adjust the reflected light intensity in the pixel 2, by changing, for example, density of the color of the color filter 22A, or the number (concentration) of the migrating particles 32 moving to the display surface side. Assume that three sub-pixels among the four sub-pixels are provided with the color filter 22A, as illustrated in Part (D) of FIG. 2. In this case, it is possible to perform the white display, by adjusting color-mixture balance between reflected light of the color filter 22A provided in the sub-pixels 2n₂, 2n₃, and 2n₄, and reflected light from the sub-pixel 2n₁. Specifically, it is possible to perform the white display by, for example, moving the migrating particles 32 to the display surface side in any of the sub-pixels 2n₂, 2n₃, and 2n₄, thereby adjusting the concentration of the migrating particles 32.

Further, assume that the selected sub-pixel is a sub-pixel (here, the sub-pixel 2n₁) provided with the color filter 22A as illustrated in Part (B) of FIG. 5. In this case, the display color in the pixel 2 is the black display by subtractive color mixture.

Furthermore, assume that all of the sub-pixels 2n₁, 2n₂, 2n₃, and 2n₄ of the pixel 2 are selected as illustrated in Part (C) of FIG. 5. In this case, the display color of the pixel 2 is the color of the migrating particles 32, here, the red display.

In this way, when the display unit 1 in the present embodiment is observed from the display substrate 20 side, the sub-pixel in the bright display state and the sub-pixel in the dark display state are both present. In addition, combined light of the color light generated from each of the sub-pixels is visually recognized. In the entire display unit 1, the contrast is therefore effected by utilizing a display color difference for each of the pixels 2 by the combined light of the sub-pixels 2n₁, 2n₂, 2n₃, and 2n₄. Besides, a color tone is determined by the additive color mixture or the subtractive color mixture. In this way, the display color is changed for each of the pixels 2 each formed of the sub-pixels 2n₁, 2n₂, 2n₃, and 2n₄, and the four color display is thereby performed.

It is to be noted that an amount of movement of the migrating particles 32 is controlled by controlling, for example, a magnitude of a drive voltage applied to each of the pixels, or an application time. This makes it possible to express each scale.

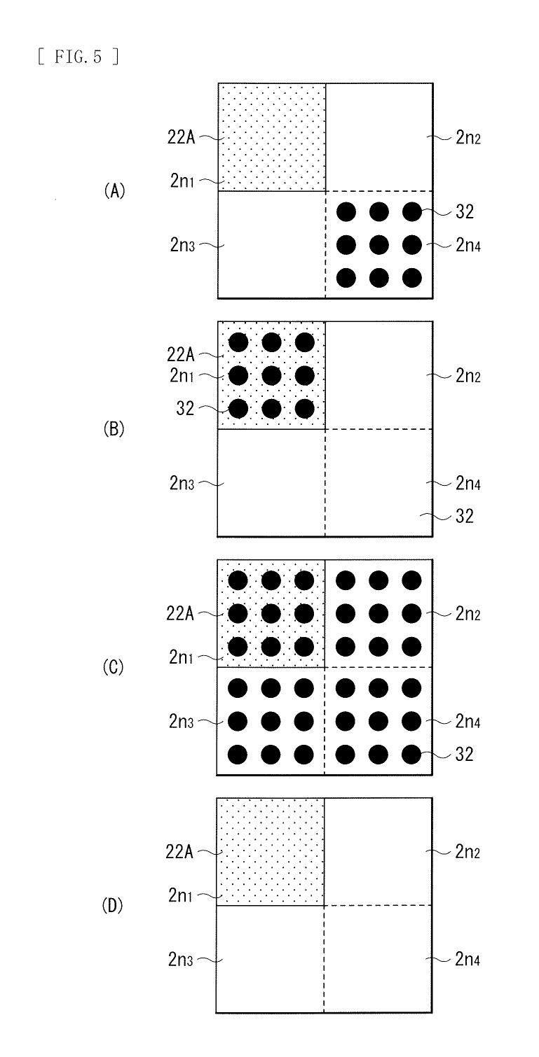

In general, color display in a display unit using an electrophoretic element in the display layer 30 may be implemented, for example, as illustrated in FIG. 6. Specifically, this color display may be implemented by providing color filters 220R, 220G, and 220B in respective sub-pixels, on a display substrate (not illustrated). The color filters 220R, 220G, and 220B correspond to three colors of R, G, and B (Part (A) of FIG. 6) or four colors (Part (B) of FIG. 6) including white (W) in addition to the three colors.

Assume that the color display is performed by simply providing the color filters 220R, 220G, and 220B for any of sub-pixels 200n₁, 200n₂, 200n₃, and 200n₄ of a pixel 200. In this case, white reflectance decreases, and display quality drops. In addition, it is difficult to perform black display, when migrating particles are colored without providing the color filters 220R, 220G, and 220B.

In contrast, in the display unit 1 of the present embodiment, a portion (e.g., the sub-pixel 2n₁) of the pixel 2 is provided with the color filter 22A. In addition, the color of the migrating particles 32 of the electrophoretic element 30A is complementary to the color of the color filter 22A. The display unit 1 is therefore allowed to perform the four color display, by controlling the movement of the migrating particles 32 distributed in the pixel 2, between the standby region R1 and the display region R2, for each of the sub-pixels 2n₁, 2n₂, 2n₃, and 2n₄.

Specifically, when the migrating particles 32 are localized on the standby region R1 side in all of the sub-pixels 2n₁, 2n₂, 2n₃, and 2n₄, the display color is the color (e.g., cyan display) of the color filter 22A. When the migrating particles 32 move to the display region R2 side in one sub-pixel (e.g., the sub-pixel 2n₄) region other than the region (e.g., the sub-pixel 2n₁) where the color filter 22A is disposed, the display color is white. When the migrating particles 32 move to the display region R2 side in the region (e.g., the sub-pixel 2n₁) where the color filter 22A is disposed, the display color is black. When the migrating particles 32 move to the display region R2 side in all of the sub-pixels 2n₁, 2n₂, 2n₃, and 2n₄ of the pixel including the color filter 22A, the display color is the color (e.g., red) of the migrating particles.

As described above, in the present embodiment, the portion of the pixel 2 is provided with the color filter 22A. In addition, the particles colored in the color complementary to the color of the color filter 22A are used as the migrating particles 32 of the electrophoretic element 30A. Moreover, the migrating particles 32 perform the dark display and the porous layer 33 performs the bright display, in the electrophoretic element 30A. The display unit 1 is therefore allowed to perform the four color display, by controlling the movement of the migrating particles 32 between the standby region R1 and the display region R2 for each of the sub-pixels 2n₁, 2n₂, 2n₃, and 2n₄ of the pixel 2. Hence, it is possible to provide a display unit in which white reflectance is high, and display quality is improved, and polychromatic display is possible.

### 2. Application Examples

Next, application examples of the display unit 1 of the above-described embodiment will be described. A configuration of each electronic apparatus to be described below is only an example, and therefore the configuration is modifiable as appropriate.

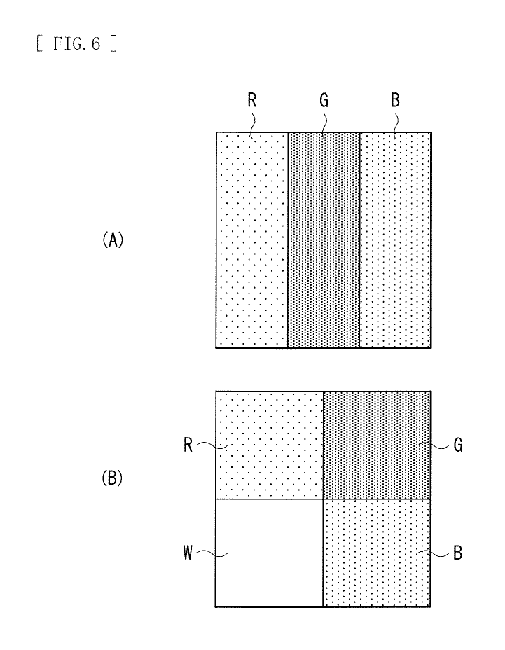

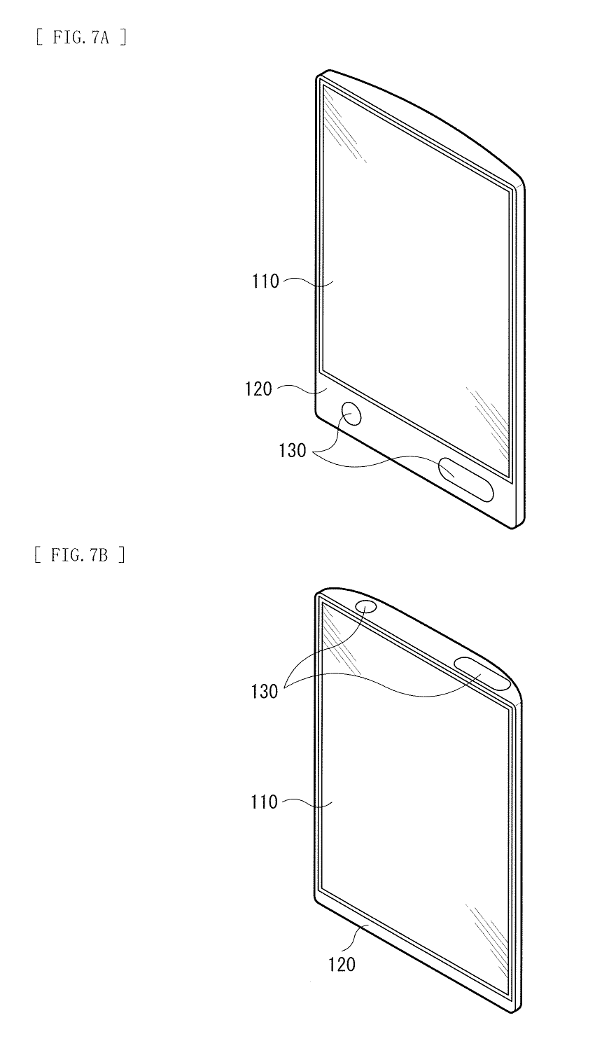

FIG. 7 illustrates appearance configurations of an electronic book. This electronic book may include, for example, a display section 110 (the display unit 1), a non-display section (a housing) 120, and an operation section 130. The operation section 130 may be provided either on a front surface of the non-display section 120 as illustrated in Part (A), or on a top surface of the non-display section 120 as illustrated in Part (B). The display unit 1 may be mounted on an apparatus such as a PDA having a configuration similar to that of the electronic book illustrated in FIG. 7.

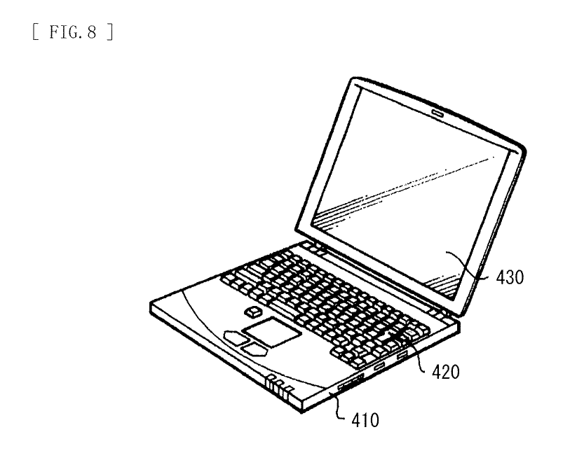

FIG. 8 illustrates an appearance configuration of a notebook personal computer. This notebook personal computer may include, for example, a main body 410, a keyboard 420 for operation of inputting information such as characters, and a display section 430 (the display unit 1) that displays an image.

In addition, the display unit 1 of the above-described embodiment may be applied to an apparatus such as an electric bulletin board.

The embodiment has been described above, but contents of the present disclosure are not limited to the embodiment described above, and various kinds of modifications may be made. For example, in the above-described embodiment, there is described the case where the four color display is performed using mainly cyan for the color filter 22A and red for the migrating particles 32. However, other colors may be used as long as there is a complementary color relationship between both sides. In addition, in the above-described embodiment, the case where the pixel 2 includes the four sub-pixels is described as an example. However, the pixel 2 may include two sub-pixels or three sub-pixels, or five or more sub-pixels.

Furthermore, in the above-described embodiment, the case where the configuration including the insulating liquid 31, the electrophoretic element 32, and the porous layer 33 is provided as the electrophoretic element 30A (the display layer 30) is described as an example. However, the configuration of the display layer 30 is not limited to the configuration using the porous layer 33 described above. The configuration of the display layer 30 may be any configuration as long as it is possible to achieve contrast formation by light reflection for each pixel by utilizing an electrophoresis phenomenon

It is to be noted that the effects described herein are mere examples without being limitative, and other effects may be also provided.

It is to be noted that the present disclosure may adopt the following configurations.
(1) A display unit, including:
   a display layer having a plurality of pixels, the pixels each including an electrophoretic element; and
   a color filter provided on a display side of the display layer on a portion of each of the pixels,
   wherein the electrophoretic element in each of the pixels includes migrating particles, and one of the migrating particles and the color filter is a primary color, and the other is a color complementary to the primary color.
(2) The display unit according to (1), wherein a plurality of pixel electrodes independent of each other are provided in each of the pixels.
(3) The display unit according to (1) or (2), wherein each of the pixels includes two or more sub-pixels.
(4) The display unit according to any one of (1) to (3), wherein one of the migrating particles and the color filter is red and the other is cyan.
(5) The display unit according to any one of (1) to (4), wherein one of the migrating particles and the color filter is green and the other is magenta.
(6) The display unit according to any one of (1) to (5), wherein one of the migrating particles and the color filter is blue and the other is yellow.
(7) The display unit according to any one of (1) to (6), wherein four color display is possible.
(8) The display unit according to any one of (1) to (7), further including an electrode, a support base, and a bonding layer between the display layer and the color filter, in order from a side where the display layer is provided.
(9) The display unit according to (8), wherein the display layer includes a porous film and an insulating liquid, the porous film being configured of a fibrous structure.
(10) An electronic apparatus provided with a display unit, the display unit including:
   a display layer having a plurality of pixels, the pixels each including an electrophoretic element; and
   a color filter provided on a display side of the display layer on a portion of each of the pixels,
   wherein the electrophoretic element in each of the pixels includes migrating particles, and one of the migrating particles and the color filter is a primary color, and the other is a color complementary to the primary color.

The present application is based on and claims priority from Japanese Patent Application No. 2014-187434 filed in the Japan Patent Office on Sep. 16, 2014, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A display unit, comprising:
a display layer having a plurality of pixels, the pixels each including an electrophoretic element; and
a color filter provided on a display side of the display layer on a portion of each of the pixels,
wherein the electrophoretic element in each of the pixels includes migrating particles, and one of the migrating particles and the color filter is a primary color, and the other is a color complementary to the primary color.

2. The display unit according to claim 1, wherein a plurality of pixel electrodes independent of each other are provided in each of the pixels.

3. The display unit according to claim 1, wherein each of the pixels includes two or more sub-pixels.

4. The display unit according to claim 1, wherein one of the migrating particles and the color filter is red and the other is cyan.

5. The display unit according to claim 1, wherein one of the migrating particles and the color filter is green and the other is magenta.

6. The display unit according to claim 1, wherein one of the migrating particles and the color filter is blue and the other is yellow.

7. The display unit according to claim 1, wherein four color display is possible.

8. The display unit according to claim 1, further comprising an electrode, a support base, and a bonding layer between the display layer and the color filter, in order from a side where the display layer is provided.

9. The display unit according to claim 1, wherein the display layer includes a porous film and an insulating liquid, the porous film being configured of a fibrous structure.

10. An electronic apparatus provided with a display unit, the display unit comprising:
a display layer having a plurality of pixels, the pixels each including an electrophoretic element; and
a color filter provided on a display side of the display layer on a portion of each of the pixels,
wherein the electrophoretic element in each of the pixels includes migrating particles, and one of the migrating particles and the color filter is a primary color, and the other is a color complementary to the primary color.
